(19) United States
(12) Patent Application Publication
(10) Pub. No.: US 2025/0097003 A1
(43) Pub. Date: Mar. 20, 2025

(54) VERFAHREN ZUR KONTAKTLOSEN ÜBERTRAGUNG SERIELLER SIGNALE UND ÜBERTRAGUNGSEINRICHTUNG HIERFÜR

(71) Applicant: SMW-electronics GmbH, Meckenbeuren (DE)

(72) Inventor: René Hoffmann-Schneider, Lindau (DE)

(21) Appl. No.: 18/885,910

(22) Filed: Sep. 16, 2024

(30) Foreign Application Priority Data
Sep. 14, 2023 (EP) 23197421.3

(51) Int. Cl. H04L 7/02; H04L 1/00

(52) U.S. Cl. CPC H04L 7/02; H04L 1/0002

(57) ABSTRACT

For transfer via an inductive interface, a serial signal may be sampled at a bit rate that is significantly higher than the bit rate of the signal itself in order to ensure that the components of the transmitter and of the inductive interface, which generally operate at different bit rates, cooperate. However, this is costly, and frequency ranges are reached in which the transfer is susceptible to errors.

According to the invention, it is proposed to receive the signals and relay them in a delayed and synchronized manner without changing the bit rate. For this purpose, the received bits are delayed by a delay time, to be determined for each signal, and are synchronized with the bit clock of the inductive interface, which is preferably operated at the same bit rate as that of the transmitter.

### REFERENCE TO PENDING PRIOR PATENT APPLICATION

This patent application claims benefit of European Patent Application No. 23197421.3, filed Sep. 14, 2023, which patent application is hereby incorporated herein by reference.

### FIELD OF THE INVENTION

The present invention relates to a method for the contactless transfer of serial signals from a transmitter to a receiver, wherein the signals from the transmitter are received in the form of a first bit stream with a first bit clock and are evaluated by a control unit, and a delay time is set and transmitted to a delay circuit which scans all bits of the signals in the first bit stream and saves them, delayed by the delay time. The present invention further relates to a transfer device for same.

### BACKGROUND OF THE INVENTION

Such a method and such a device are already known from US 2015/207616 A1. Further reference is made to US 2020/241591 A1 and US 2018/275714 A1.

It is already known to transfer data signals of a machine controller to a receiver via an inductive coupler. With robotic arms, this routinely takes place to ensure their free rotatability. As a result of the inductive transfer, energy as well as data signals may be transferred in the direction of a gripper mounted on the robotic arm, without the need for a continuous cable line. This also allows multiple rotations, in which a cable line would twist and at some point become too short, or mechanically break.

However, on the one hand the data link must have the highest quality possible in order to completely transmit the control signals to the gripper, and on the other hand the transmission must take place as quickly as possible in order to operate in a synchronized manner.

In industry and information technology, the signals are transferred via individual lines by means of widely used serial interfaces, sometimes in duplicate with a redundant line. “Serial” means that the data to be transferred are transmitted in a bitwise manner in a temporal sequence as a serial data stream, i.e., a bit stream.

Various transfer protocols of possible interfaces in each case establish how many individual bits are combined to form a larger transfer unit, and how they are encoded using information technology. These larger transfer units are referred to in the case of an IO link, for example, as an octet, for a CAN bus or Ethernet, as a frame, and for the RS232, as a word, depending on the interface used. Within the scope of the present document, these are also referred to in general as a signal. In addition to the information to be transferred, this transfer unit may also contain defined bits for recognizing a starting position and end position, error detection and error correction, or for adapting to the physical needs of the transmission channel, i.e., for synchronization.

All of the above-mentioned transfer protocols utilize one or more strictly defined transfer rates, referred to below as bit rates. For the IO link, the transfer rates are 4.8 Kbit/s, 38.4 Kbit/s, or 230.4 Kbit/s. To form the basis for the most interference-free transfer possible, reliable tolerances concerning the temporal position, and thus the transfer rate, are sometimes very precisely specified for the transmission standards. The transmitter must comply with these tolerances, and the receiver must accept temporal deviations to a considerable extent.

If a transfer of data of the described interfaces, for example for a robotic arm, is now to take place across an air gap via an inductive transfer device, the useful signal must be adapted corresponding to the physical properties of the transmission channel, in the present case the inductive interface made up of the transmitter coils, the air gap, and the receiver coil, since the transmission channel satisfactorily transfers only [in] certain frequency ranges. In the simplest case, this could involve re-encoding of the bits to be transferred, whereas for high-performance transfers a suitable modulation process could be selected. In principle, this applies not only for inductive transfer, but also for all radio transmissions or also hard-wired transmissions such as PowerLine and DSL, and also for optical processes.

In order to still be able to transfer an acceptable bit rate via the inductive interface, which is greatly limited in bandwidth due to the inductance of the transmitter coils used there, the bits are to be synchronously transferred between the transmitter and the receiver. The synchronization of the bits means that the transmitter or the receiver is synchronized with the exact temporal location of the individual bits via a synchronization mechanism. Both sides thus have knowledge of the exact temporal location of a starting edge of the particular bit and of an ending edge of the particular bit.

For a transfer via the inductive interface, the problem arises that the temporal location of the individual bits from the serial interface of the transmitter does not match the temporal location of the transfer points in time of the inductive interface. In addition, the exact frequencies of both bit rates themselves are different due to tolerances, even if they are set to the same frequency.

To solve this problem, it is self-evident to design the inductive interface in such a way that its bit rate during the inductive transfer is a multiple of the bit rate of the serial signal. In the receiver, the bits for the serial signal output must still be resynchronized in order to meet the requirements for the serial signal. Otherwise, operations must be carried out at significantly higher clock rates, which would have to be twenty to a thousand times the bit rate of the transmitter. However, due to this great increase in the bit rate, such an approach must be considered to be very disadvantageous, since for faster interfaces at greater than 200 Kbit/s this can be inductively achieved only with very high complexity. In addition, areas are reached in which the transmission quality is not optimal.

### SUMMARY OF THE INVENTION

Against this background, the object underlying the present invention is to provide a method and a transfer device for the contactless transfer of serial signals, which minimizes delay of the transmitted message, and at the same time, adversely affects the quality of the transfer as little as possible.

This object is achieved by a method for the contactless transfer of serial signals according to the features of independent claim 1, and by a transfer device for same according to the features of independent claim 8. Meaningful embodiments of the method and of the device may be inferred from the subsequent dependent claims.

According to the invention, in this regard a method for the contactless transfer of serial signals from a transmitter to a receiver is provided, wherein the signals from the transmitter are received in the form of a first bit stream with a first bit clock and are evaluated by a control unit, a search is made for a start bit of a signal within the first bit stream, using the control unit, and a delay time is set and transmitted to a delay circuit which scans all bits of the signals in the first bit stream and sequentially saves them, delayed by the delay time, in a FIFO memory, in each case for a second bit clock, and for reading out from the FIFO memory, pending bits are in each case sequentially read out synchronously with the second bit clock, and transferred as a second bit stream via an air gap by means of an inductive transmitting unit stream and transmitted to the receiver.

Furthermore, according to the invention a transfer device for the contactless transfer of serial signals from a transmitter that transmits in a first bit clock to a receiver is provided, comprising an inductive transmitting unit that transmits with a second bit clock, a control unit for evaluating received signals and for setting a delay time, a FIFO memory for delayed buffering of the signals, and a delay circuit for sampling all bits of the signals and their relay, delayed by the delay time, to the FIFO memory, wherein the control unit is data-linked to the inductive transmitting unit, the delay circuit, and the FIFO memory, and the inductive transfer device includes an inductive transmitting unit which via an air gap is separated from an inductive receiving unit, which in turn is data-linked to the receiver.

Instead, by increasing the sampling rate to ensure that the original signals can be exactly detected and reproduced, the amount of deviation of a first bit clock of the transmitter from a second bit clock of the inductive transfer device is determined. Accordingly, the signal is shifted by a delay in such a way that the first bit stream of the arriving signal is inductively transferred, synchronously with the second bit clock of the inductive transfer device, and is passed on to the receiver, which takes place via a delay element and entry into a FIFO memory, i.e., a memory in which the bit that is first written is also the first that is read out. As a result, the transfer of the signal via the inductive transfer device takes place with only a minimal time delay.

In particular, this may take place by the control unit detecting a time offset between the first bit clock and the second bit clock, and setting the delay time in such a way that it corresponds at least to the time interval between an ending edge of the start bit and the next edge of the second bit clock, and at most corresponds to the time interval between a starting edge of the start bit and the next edge of the second bit clock, but a middle range of each bit received in the first bit clock is preferably synchronized with the second bit clock. Signals, as customarily graphically represented, are never exactly rectangular. Instead, overshooting occurs at the edges before the signals settle to the predefined value. Therefore, to always have the most reliable value possible, the delay may be selected in such a way that the sampling of the first bit stream always takes place in a middle range of the particular bit, in which a steady state is reached.

The control unit may preferably compare each signal to a template, and may supplement missing end bits if necessary if they are not received within the signal. Since an end bit may possibly no longer be sampled due to the delays and within the scope of the predefined tolerances, the control unit monitors the makeup of the signals and compares them to the template, which is known. For an RS232 word, for example a start bit is set at zero and is followed by 8 bits of information, then by a parity bit, and lastly by a stop bit that is held for a quiescent period. If the stop bit is to be truncated, based on the information that is predefined in the control unit it may be supplemented via the protocol used, and also moved into the FIFO memory if the stop bit has not been sampled.

It may be provided that the control unit sets a separate delay time for each signal. To ensure that individual bits are not permanently truncated from the signals due to the applicable tolerances, the synchronization may advantageously take place anew for each signal.

It may be particularly advantageous for the second bit clock of the inductive transmitting unit to have the same clock rate as the first bit clock, preferably corresponding to a highest possible first bit clock of the transmitter for a signal protocol that is used, or to an integer multiple thereof. Since in the present method it is not necessary to change the clock rate due to the fact that sampling does not have to be performed at a higher resolution, the inductive transfer may take place with customary clocking. Therefore, it is not necessary to carry out further synchronization after the inductive transfer, since the receiver already obtains the received signal at the expected clock rate. This is also possible if the transfer is to be carried out at a higher clock rate; for this purpose an integer multiple may preferably be selected so that multiple signals may be transferred in the period of a signal. In the reverse direction, this may then simply be output back to the receiver, for example via a further FIFO memory. In this regard, it is particularly advantageous when clock rates of 4.8 Kbit/s, 38.4 Kbit/s, or 230.4 Kbit/s are provided as the first bit clock.

Furthermore, it may be provided that the control unit, using suitable means for determining the clock rate of the first bit clock, ascertains same and uses it for synchronization with the second bit clock. The clock rate of the second bit clock is basically known to the control unit; however, within the scope of the communication with the transmitter, the clock rate of the transmitter may either be negotiated with the transmitter at the outset, or determined from the signals themselves by time measurement.

Within a cycle of the second bit clock, it is likewise preferably possible to simultaneously transfer multiple bits of a signal or of multiple signals of the transmitter to the receiver. In the case of such a multiplex process, the signals may be superimposed on one another, for example by modulation or demodulation, so that faster and more extensive communication may take place. This may be meaningful in particular when a plurality of devices, i.e., multiple grippers, sensors, actuators, or controllers, are to be activated via a single inductive transmitting unit. For this purpose, a multiplexer may be associated with the transfer device on the side of the inductive transmitter, in which case it would be necessary to provide a demultiplexer on the side of the inductive receiver.

In one specific embodiment, it may be provided that the transfer device is designed completely in software on a CPU, in programmable logic on an FPGA or a CPLD, in integrated logic on an IC or ASIC, or with hard-wired logic, or from a mixture of such components. Since the transfer device is formed mostly from simple components, there are numerous implementation options that may be meaningfully used.

Lastly, the inductive transmitting unit may have a bidirectional design, i.e., may either have combined inductive transmitting units and receiving units on both sides, or may have an inductive transmitting unit and an inductive receiving unit on each side. This allows signals to be transported in both directions via the air gap, for example control signals in the direction of the robotic arm, and allows confirmations and error messages as well as measured values from sensors to be transported in the opposite direction. In the case of use of the same devices on both sides as transmitter coils and receiver coils, it may be meaningful to use one-half the time for each direction, so that the above-described methods of using bit rates with multiples of the first bit rate and using multiplexers may also be employed for this case, in order to transfer the necessary data in the correct time window, despite the elimination of effective transmission time.

### BRIEF DESCRIPTION OF THE DRAWINGS

The above-described invention is explained in greater detail below with reference to one exemplary embodiment.

In the figures:

FIG. 1 shows a schematic wiring diagram of a transfer device, including a transmitter and a receiver, and

FIG. 2 shows a schematic illustration of the bit clocks and bit streams of the transmitter and the inductive transmitting unit.

### DETAILED DESCRIPTION OF THE PREFERRED EMBODIMENTS

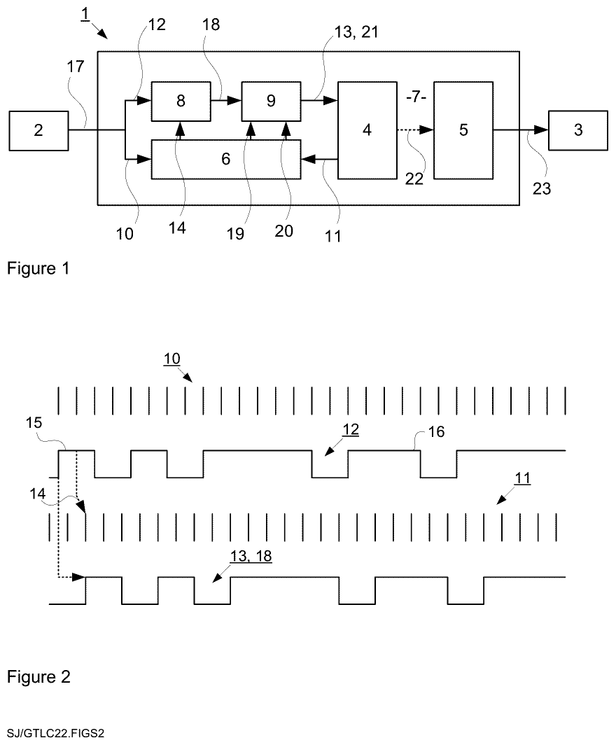

FIG. 1 shows a schematic wiring diagram in which a transfer device 1 is data-linked to a transmitter 2 and a receiver 3. The transmitter 2 is intended to transmit signals 17 to the receiver 3 by means of the transfer device 1. The transmitter 2 is situated on a base of a robotic arm, and the receiver 3 is situated on the rotatably supported robotic arm itself. Present between the transmitter 2 and the receiver 3 on account of the free rotatability of the robotic arm is an air gap 7 that is to be bridged by inductive transfer 22 via a pair of coils made up of an inductive transmitting unit 4 and an inductive receiving unit 5.

The signal 17 has a serial design and includes a bit stream 12, illustrated in FIG. 2. A first bit clock 10 used by the transmitter 2 differs from a second bit clock 11 used in the transfer device 1; however, in the present example the clock rates of the two bit clocks 10 and 11 are selected to be the same, so that the transfer device 1 transfers signals 17 at the same bit rate as the transmitter 2.

When a signal 17 is present for transfer, it is examined and sampled by a control unit 6 of the transfer device 1. The first bit clock 10 is initially detected and compared to the second bit clock 11 of the inductive transmitting unit 4 to determine how the two bit clocks 10 and 11 relate to one another. At this point the control unit 6 determines that the clock rates are equal on both sides, but are not synchronous. The control unit 6 will thus set a delay time 14 which ensures that a range in the middle of a bit, ideally a start bit 15, is present when the value of the bit in question is read out.

The delay time 14 set by the control unit 6 is relayed to a delay circuit 8, which receives the first bit stream 12 from the transmitter 2. The individual bits of the first bit stream 12, delayed by the delay time 14, are written as a delayed signal 18 in the form of a second bit stream 13 into a FIFO memory 9; here as well, the particular write signal 19 goes from the control unit 6 to the FIFO memory 9. If a comparison of the delayed signal 18, stored in the FIFO memory 9, to a template of the transfer protocol shows that a stop bit 16 has been truncated due to delays and tolerances, this is written into the FIFO memory based on an additional write signal 19 of the control unit 6.

Based on a read signal 20 of the control unit 6, in each case a bit of the delayed signal 18 is then read out in a second bit stream 13 for the second bit clock 11, and as a synchronized signal 21 is transferred from the inductive transmitting unit 4 in the manner of an inductive transfer 22, to the inductive receiving unit 5, and across the air gap 7. The signal 23 that is now transferred across the air gap 7 is transmitted to the receiver 3, and ultimately reaches the receiver 3, delayed only by the delay time 4 with respect to the first bit clock 10, at the same bit rate.

Thus, a method and a transfer device for the contactless transfer of serial signals are described above which minimize delay of the transmitted message, and at the same time, adversely affect the quality of the transfer as little as possible.

### LIST OR REFERENCE NUMERALS

1 transfer device
2 transmitter
3 receiver
4 inductive transmitting unit
5 inductive receiving unit
6 control unit
7 air gap
8 delay circuit
9 FIFO memory
10 first bit clock
11 second bit clock
12 first bit stream
13 second bit stream
14 delay time
15 start bit
16 end bits
17 serial signal
18 delayed signal
19 FIFO write signal
20 FIFO read signal
21 synchronized signal
22 inductive transfer
23 transferred signal

1. A method for the contactless transfer of serial signals (17) from a transmitter (2) to a receiver (3), wherein the signals (17) from the transmitter (2) are received in the form of a first bit stream (12) with a first bit clock (10) and are evaluated by a control unit (6), and a delay time (14) is set and transmitted to a delay circuit (8) which scans all bits of the signals (17) in the first bit stream (12) and saves them, delayed by the delay time (14), characterized in that a search is made for a start bit (15) of a signal (17) within the first bit stream (12), using the control unit (6), and the delay circuit (8) sequentially saves all bits of the signals (17) in a FIFO memory (9), in each case for a second bit clock (11), and for reading out from the FIFO memory (9), pending bits are in each case sequentially read out synchronously with the second bit clock (11), and transferred as a second bit stream (13) via an air gap (7) by means of an inductive transmitting unit stream and transmitted to the receiver (3), wherein the second bit clock (11) is the bit clock of the inductive transmitting unit, and the control unit (6) detects a time offset between the first bit clock (10) and the second bit clock (11), and sets the delay time (14) in such a way that it corresponds at least to the time interval between an ending edge of the start bit (15) and the next edge of the second bit clock (11), and at most corresponds to the time interval between a starting edge of the start bit (15) and the next edge of the second bit clock (11), but a middle range of each bit received in the first bit clock (10) is preferably synchronized with the second bit clock (11).

2. The method according to claim 1, characterized in that the control unit (6) compares each signal (17) to a template, and supplements missing end bits (16) if necessary if they are not received within the signal (17).

3. The method according claim 1, characterized in that the control unit (6) sets a separate delay time (14) for each signal (17).

4. The method according claim 1, characterized in that the second bit clock (11) of the inductive transmitting unit has the same clock rate as the first bit clock (10), preferably corresponding to a highest possible first bit clock (10) of the transmitter (2) for a signal protocol that is used, or to an integer multiple thereof.

5. The method according to claim 4, characterized in that clock rates of 4.8 Kbit/s, 38.4 Kbit/s, or 230.4 Kbit/s are provided as the first bit clock (10).

6. The method according to claim 1, characterized in that the control unit (6) determines the clock rate of the first bit clock (10) and uses it for synchronization with the second bit clock (11).

7. The method according to claim 1, characterized in that within a cycle of the second bit clock (11), multiple bits of a signal (17) or of multiple signals (17) of the transmitter (2) are simultaneously transferred to the receiver (3).

8. A transfer device for the contactless transfer of serial signals (17) from a transmitter (2) that transmits in a first bit clock (10) to a receiver (3), comprising a control unit (6) for evaluating received signals (17) and for setting a delay time (14),
characterized in that the transfer device further includes an inductive transmitting unit that transmits with its own bit clock as a second bit clock (11), a FIFO memory (9) for delayed buffering of the signals (17), and a delay circuit (8) for sampling all bits of the signals (17) and their relaying, delayed by the delay time (14), to the FIFO memory (9), wherein the control unit (6) is data-linked to the inductive transmitting unit, the delay circuit (8), and the FIFO memory (9), and the inductive transfer device includes an inductive transmitting unit (4) which via an air gap (7) is separated from an inductive receiving unit (5), which in turn is data-linked to the receiver (3), wherein the control unit (6) has means for detecting a time offset between the first bit clock (10) and the second bit clock (11), and the delay time (14) is settable by the control unit (6) in such a way that the delay time corresponds at least to the time interval between an ending edge of the start bit (15) and the next edge of the second bit clock (11), and at most corresponds to the time interval between a starting edge of the start bit (15) and the next edge of the second bit clock (11), but a middle range of each bit received in the first bit clock (10) is preferably synchronizable with the second bit clock (11).

9. The transfer device according to claim 8, characterized in that the control unit (6) has means for setting a clock rate of the first bit clock (10).

10. The transfer device according to claim 8, characterized in that the control unit (6) has a multiplexer for simultaneously transferring multiple signals via the inductive transmitting unit.

11. The transfer device according to claim 8, characterized in that the transfer device is designed completely in software on a CPU, in programmable logic on an FPGA or a CPLD, in integrated logic on an IC or ASIC, or with hard-wired logic, or from a mixture of such components.

12. The transfer device according to claim 8, characterized in that the inductive transmitting unit has a bidirectional design, i.e., either has combined inductive transmitting units and receiving units on both sides, or has an inductive transmitting unit (4) and an inductive receiving unit (5) on each side.
